(19) United States
(12) Patent Application Publication
(10) Pub. No.: US 2010/0073660 A1
(43) Pub. Date: Mar. 25, 2010

(54) SPECTRALLY CONTROLLED HIGH ENERGY DENSITY LIGHT SOURCE PHOTOPOLYMER EXPOSURE SYSTEM

(75) Inventor: Frank A. Hull, Cedar, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: NEWCORT, LLC, Minneapolis, MN (US)

(21) Appl. No.: 12/524,698

(22) PCT Filed: Jan. 30, 2008
(86) PCT No.: PCT/US08/01237

§ 371 Date: Jul. 27, 2009

Related U.S. Application Data
(60) Provisional application No. 60/898,423, filed on Jan. 30, 2007.

(51) Int. Cl. G03B 27/54

(52) U.S. Cl. 355/70; 355/71

(57) ABSTRACT

A system for forming printing features (10) on a printing plate includes a high energy density light source (20) that has an emission spectrum that includes actinic radiation and non-actinic radiation. A reflector assembly (22) directs light produced by the high energy density light source (20) in a light path. The printing plate (28) has a mask that defines locations of the printing features. A filter (24) is situated in the light path between the high energy density light source (20) and the printing plate (28), and is configured to remove the non-actinic radiation produced by the high energy density light source (20). A relative motion system (26/30, 32) is provided to cause the light emitted by the high energy density light source (20) to move with respect to the printing plate (28).

### BACKGROUND

The present invention relates to a photopolymer exposure system in which a scanning light source is employed to provide only relatively long wavelength ultraviolet (UV) light (i.e., actinic radiation) to a flexographic printing plate, suppressing short wavelength UV light that would otherwise have an adverse effect on the shape and profile of features formed on the plate.

In flexographic printing processes, it is important for the raised features of the flexographic printing plate to have a well controlled shape and profile, with the relationship between the height of the feature, the width at the bottom of the feature, and the width at the top of the feature being precisely controlled.

The process of forming a flexographic plate involves ablating the carbon overcoat of the plate, which creates an image mask over the photopolymer material of the plate, and then exposing the unmasked portions of the plate to high intensity UV light. The high intensity light cures or cross-links the photopolymer material of the plate, creating a solid cross-linked feature in the exposed areas. The areas covered by the image mask are not exposed, and remain in a non-solid, uncured state.

It has previously not been possible in the flexographic printing industry to employ a high energy density, non-coherent light source to expose a flexographic plate, as the use of such a light source resulted in a lack of control over the feature shape and profile on the plate. As a result, it has previously not been possible to provide a scanning light source to expose a flexographic plate, since a high energy density light source is needed in a scanning system to provide the necessary total energy to expose the plate properly. Instead, existing systems employ relatively low energy density bank lights having phosphors that emit light at wavelengths that are tuned to the photoinitiators that are used in flexographic plates, so that consistently controllable feature shapes are achieved. Phosphor-based bank lights emit virtually no low frequency radiation, and research by the present inventor has shown that this characteristic is one reason why phosphor-based bank lights are able to produce controllable feature shapes and profiles. However, phosphor-based bank lights are space-consuming and require relatively long exposure times due to the low energy density light that they produce. It would be useful in the art to provide a system in which a high energy density light source could be used to form printing features on flexographic printing plates, and also for the system to be capable of forming these features by scanning across the surface of the plate.

### SUMMARY

The present invention is a system and method for forming printing features on a printing plate. A high energy density light source produces light that includes actinic radiation and non-actinic radiation. A reflector assembly directs light produced by the high energy density light source in a light path. The printing plate has a mask that defines locations of the printing features. A filter is situated in the light path between the high energy density light source and the printing plate, and is configured to remove the non-actinic radiation produced by the high energy density light source. A relative motion system is provided to cause the light emitted by the high energy density light source to move with respect to the printing plate.

### BRIEF DESCRIPTION OF THE DRAWINGS

FIG. 1 is a diagram illustrating a desirable printing feature shape and profile.

FIG. 2 is a graph illustrating exemplary emission characteristics of phosphor-based bank lights.

FIG. 3 is a graph illustrating the absorption spectrum of a typical flexographic printing plate photopolymer.

FIG. 4 is a graph illustrating the extinction factor of typical photoinitiators used in flexographic printing plates.

FIG. 5 is a diagram illustrating the undesirable feature shape and profile that has been obtained in prior attempts to utilize a scanning high energy density light source for flexographic printing plate exposure.

FIG. 6 is a diagram illustrating a scanning, high energy density light source exposure system for flexographic printing plates according to an embodiment of the present invention that is able to achieve the desirable printing feature shape and profile shown in FIG. 1.

FIG. 7 is a graph illustrating the emission spectrum of an exemplary high energy density light source utilized in an embodiment of the present invention, showing the short wavelength suppression achieved by a composite filter.

FIG. 8 is a graph illustrating the transmission characteristics of a composite filter including a transmission filter substrate that rejects radiation having a wavelength less than that of actinic radiation and a dielectric coating that absorbs radiation having a wavelength greater than that of actinic radiation.

### DETAILED DESCRIPTION

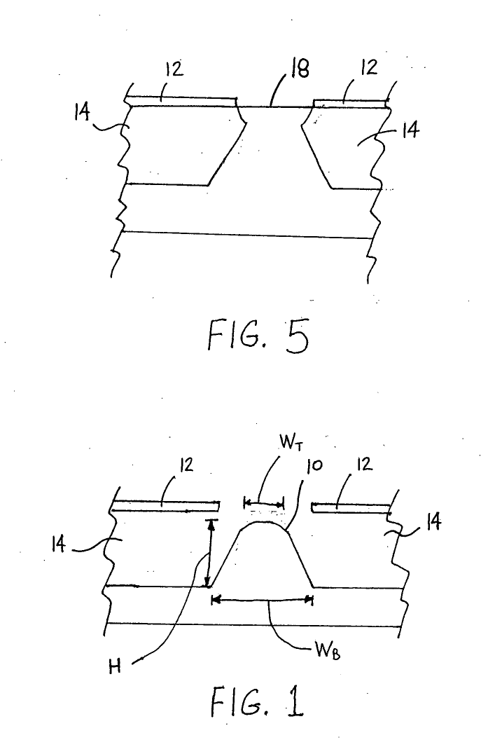

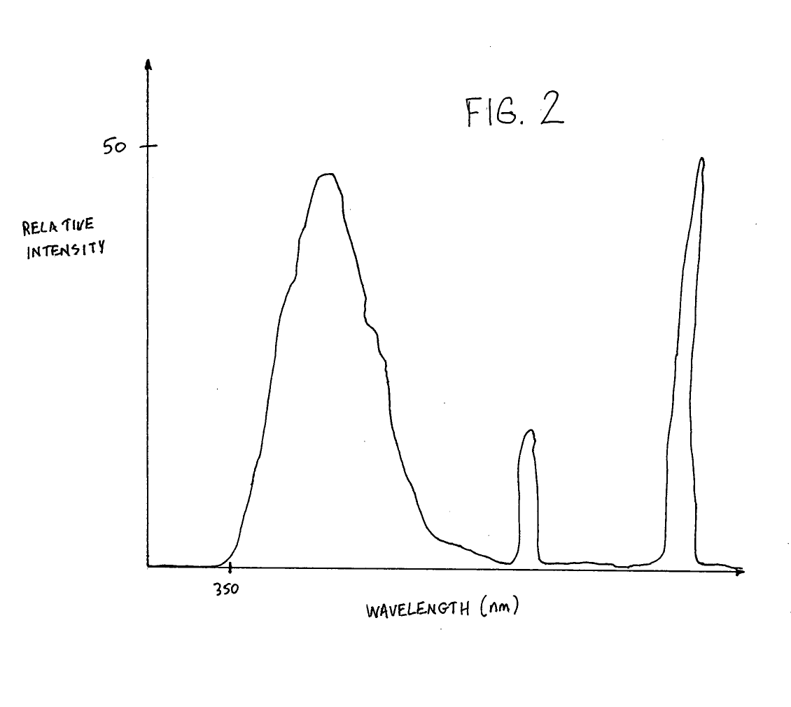

FIG. 1 is a diagram illustrating a desired shape and profile of printing feature 10 on a flexographic printing plate. As was discussed above, the process of forming a flexographic plate involves ablating the carbon overcoat of the plate, which creates image mask 12 over the photopolymer material of the plate, and then exposing the unmasked portions of the plate to high intensity UV light. The high intensity light cures or cross-links the photopolymer material of the plate, creating solid cross-linked feature 10 in the exposed areas. Areas 14 covered by the image mask are not exposed, and remain in a non-solid, uncured state.

Printing feature 10 is preferably formed with a precisely controlled height (H), width at the bottom of the feature (W_{B}), width at the top of the feature (W_{T}), and shape (resembling a relatively steep hill as generally shown in FIG. 1). In existing systems, phosphor-based bank lighting has been required to achieve this feature shape and profile, as efforts to utilize scanning, high energy density, non-coherent light source-based systems have resulted in poor control over the features formed on the flexographic plate.

The present inventor has discovered that at least part of the problem experienced in the past with high energy density light sources is due to the effect of the absorption spectra of the polymers and the spectral response of the photoinitiators used in the production of the photopolymer material of flexographic plates, which have an extinction factor that is much greater in the shorter UV wavelengths (i.e., below about 350 nanometers (nm)).

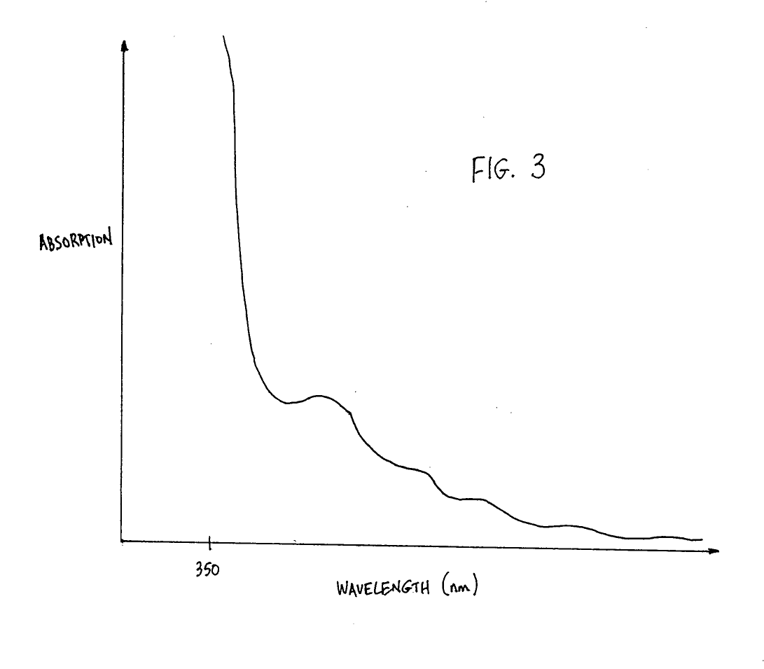

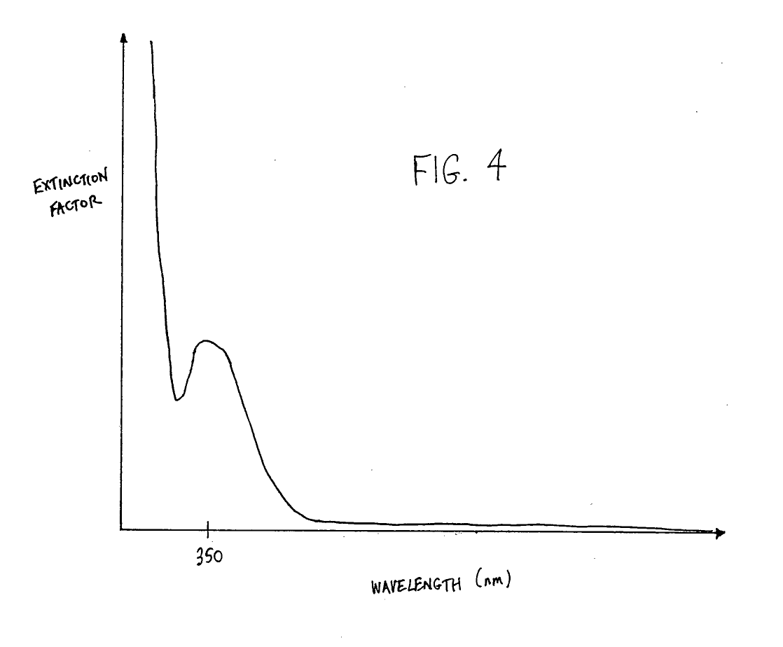

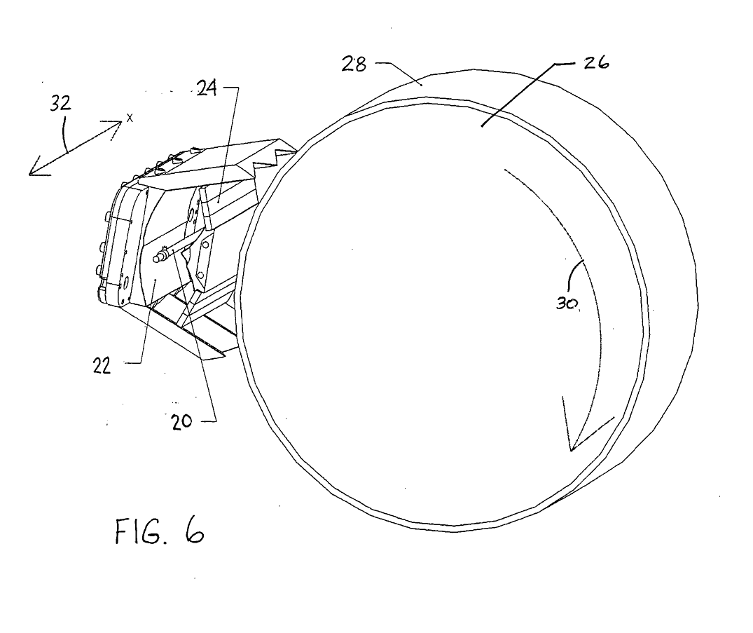

FIG. 3 illustrates the absorption spectrum of a typical photopolymer, showing high levels of absorption at short wavelengths. FIG. 4 illustrates the extinction factor of typical photoinitiators, showing high sensitivity at short wavelengths. These factors mean that UV light in the shorter wavelengths does not penetrate as deep into the photopolymer as would UV light in longer wavelengths, and due to the greater sensitivity of the photoinitiators at shorter wavelengths, results in greatly increased curing at the surface of the plate as compared to the base of the feature being formed. As a result, features formed by light that includes significant shorter wavelength components tend to have a greater amount of cross-linked area at the surface where the light strikes the photopolymer, which can yield an undesirable feature profile. FIG. 5 is a diagram illustrating undesirable printing feature 18, which has an overly large amount of cured material at the surface of the flexographic plate (compared to the desirable feature profile shown in FIG. 1). This problem has inhibited the development of flexographic exposure systems that employ high energy density light sources, since those sources (e.g., mercury discharge lamps, halide lamps, etc.) output UV light in wavelengths below about 350 nm.

In addition, manufacturing and ablation of a flexographic plate exposes the surface of the plate to oxygen. The photopolymer material of the plate will not fully cure if oxygen is present, leaving some uncured material near the top surface of printing features. This uncured material is removed in later processing, so that the top surfaces of the features are actually sharpened (this phenomenon is known as oxygen sharpening). Oxygen sharpening does not occur as well when high energy density light sources are used, because the high energy density light sources burn the oxygen away at the top surface of the polymer material, so that the cross-linked areas forming the top of the features tend to be larger and result in the undesirable feature profile shown in FIG. 5.

FIG. 6 is a diagram illustrating a scanning, high energy density light source exposure system for flexographic printing plates according to an embodiment of the present invention that is able to achieve the desirable printing feature shape and profile shown in FIG. 1. This system includes the following elements:
High energy density light source 20 is provided having an emission spectrum that contains at least actinic (useful UV) radiation content and also emissions of wavelengths longer and/or shorter than actinic radiation. The source could be any form of mercury discharge lamp or halide lamp with doping to emit in the actinic wavelengths or any other combination of fill elements with emission in the actinic wavelengths. In a particular embodiment, the light source may be a mercury plasma arc lamp, such as a high pressure capillary type or a short arc type, which has a relatively high power density and compact size. All of these types of high energy density light sources radiate considerably outside of the desired actinic wavelengths, which would ordinarily result in a negative effect on the profile of features created on the plate.
Reflector assembly 22 is situated to collect and redirect the light produced by light source 20 toward flexographic plate 28. Reflector assembly 22 is configured with a controlled numerical aperture in order to allow control over the final feature profile.
Composite filter 24 utilizing interference coatings, internal absorption, or any combination of these, is situated in the light path between light source 20 and flexographic plate 28 to remove emissions having wavelengths that are longer and/or shorter than the actinic wavelengths. For example, a transmission filter formed of a substrate that absorbs radiation of short wavelengths (such as borasilicate in one embodiment) in combination with a coating that rejects radiation of long wavelengths (such as a dielectric coating in one embodiment) may be used. This function may be provided in many different ways, such as by a filter and coating associated with light source 20 and/or reflector assembly 22, a cover sheet provided over flexographic plate 28, or others. The coating typically is located between light source 20 and the absorbing filter/substrate, to reduce heating of the absorbing filter/substrate. The absorption response and corresponding heating caused by absorption is also controlled to ensure that the substrate does not expand beyond a threshold at which the coating of dielectric material is lost.
Flexographic photopolymer plate 28 having any of a broad range of photoinitiators may be used. A mask of some kind is employed to define the feature areas, such as an integral ablative mask or an applied photo mask.
A relative motion system is provided to cause the light emitted by light source 20 to move with respect to plate 28. The motion system can be a rotary system or a flat plane system, and may be incorporated as part of the light source assembly, part of the plate support assembly, or as a separate assembly of some kind. For example, FIG. 6 shows a linear motion system for the light source assembly (with motion in the direction indicated by arrows 32) and a rotary drum-type motion system 26 for the flexographic photopolymer plate 28.

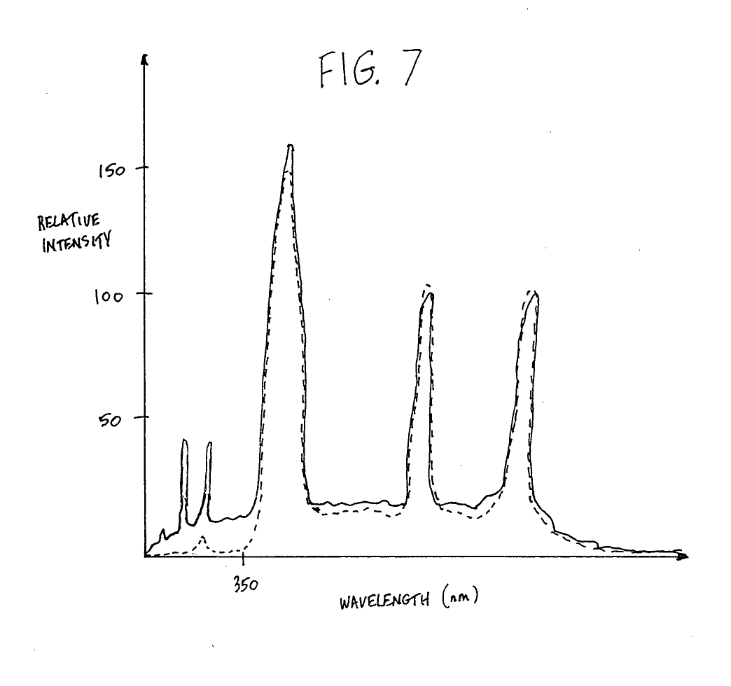

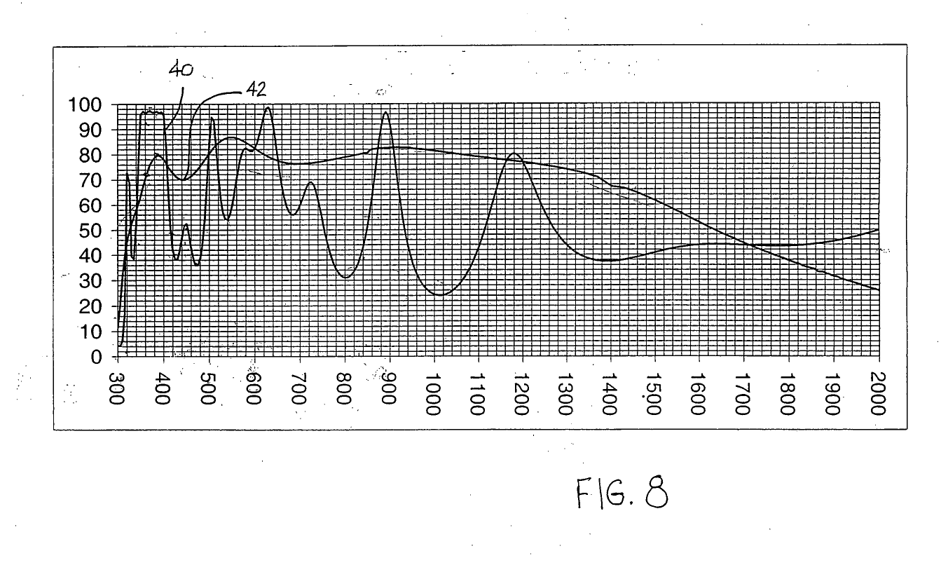

The combination of these elements results in an illumination spectrum transmitted to the photosensitive material of the plate that excludes short wavelength radiation, so that only longer wavelength actinic radiation is applied to excite the photoinitiators in the photosensitive material of the plate. FIG. 7 is a graph illustrating the emission spectrum of an exemplary high energy light source, showing the short wavelength suppression achieved by a composite filter (the transmission characteristics of which are shown in FIG. 8, which shows the transmission characteristics of both the dielectric coating (curve 40) and the transmission filter (curve 42)). Specifically, the short wavelength radiation is suppressed to be less than about one-eighth of the intensity of the longer wavelength/actinic radiation. As a result, features formed on the plate have a desirable profile as shown in FIG. 1, even though a high energy density light source is used which does not experience the effects of oxygen sharpening. This allows a scanning system to be employed using a high energy density light source, which can significantly reduce the overall time and handling costs required to expose flexographic plates. For example, existing systems utilize phosphor bank light sources that provide no more than about 30 milliwatts (mW) of actinic radiation energy per square centimeter (cm²) to expose the flexographic plate. Utilizing a configuration as described herein, a light source providing over 100 mW/cm² of actinic radiation can be used, and in fact, a light source providing about 1.2 W/cm² of actinic radiation may be used in a particular exemplary embodiment.

Although the present invention has been described with reference to preferred embodiments, workers skilled in the art will recognize that changes may be made in form and detail without departing from the spirit and scope of the invention. For example, alternative photoinitiators may be used or developed which have a different response characteristic than that shown in FIG. 4. The present invention is not limited to particular materials and products, but instead is premised on the idea that relatively short wavelength emissions from a high energy density light source are suppressed, in order to prevent excessive curing of photopolymer at the surface of a feature on a flexographic plate, thereby yielding controllable, repeatable features having a desirable profile.

1. A system for forming printing features on a printing plate, comprising:
a high energy density light source having an emission spectrum that includes actinic radiation and non-actinic radiation;
a reflector assembly for directing light produced by the high energy density light source in a light path;
a printing plate having a mask that defines locations of the printing features;
a filter situated in the light path between the high energy density light source and the printing plate, the filter being configured to remove at least a portion of the non-actinic radiation produced by the high energy density light source; and
a relative motion system operable to cause light emitted by the high energy density light source to move with respect to the printing plate.

2. The system of claim 1, wherein the high energy density light source comprises a mercury plasma arc lamp.

3. The system of claim 2, wherein the mercury plasma arc lamp is a high pressure capillary type lamp.

4. The system of claim 2, wherein the mercury plasma arc lamp is a short arc type lamp.

5. The system of claim 1, wherein the filter comprises a coating situated in the light path between the high energy density light source and the printing plate that rejects radiation having a wavelength longer than a wavelength of actinic radiation.

6. The system of claim 5, wherein the coating is a dielectric coating.

7. The system of claim 5, wherein the coating is provided on the high energy density light source and/or the reflector assembly.

8. The system of claim 5, wherein the coating is provided by a cover sheet over the printing plate.

9. The system of claim 1, wherein the filter comprises a substrate that absorbs radiation having a wavelength shorter than a wavelength of actinic radiation.

10. The system of claim 9, wherein the substrate is configured to attenuate the radiation having a wavelength shorter than a wavelength of actinic radiation to an intensity less than one-eighth of an intensity of the actinic radiation.

11. The system of claim 9, wherein the substrate is formed of borasilicate.

12. The system of claim 9, wherein the filter further comprises a coating situated in the light path between the high energy density light source and the printing plate that rejects radiation having a wavelength longer than a wavelength of actinic radiation.

13. The system of claim 12, wherein the coating is located between the high energy density light source and the substrate.

14. The system of claim 9, wherein the substrate is provided on the high energy density light source and/or the reflector assembly.

15. The system of claim 9, wherein the substrate is provided on a cover sheet over the printing plate.

16. The system of claim 1, wherein the relative motion system comprises a rotary system.

17. The system of claim 1, wherein the relative motion system comprises a flat plane system.

18. The system of claim 1, wherein the relative motion system comprises a linear motion system for moving the light source assembly.

19. The system of claim 1, wherein the relative motion system comprises a rotary drum-type motion system for moving the printing plate.

20. The system of claim 1, wherein the high energy density light source provides at least 100 milliWatts per square centimeter (mW/cm²) of actinic radiation.

21. A method of forming printing features on a printing plate, the method comprising:
providing light from a high energy density light source that includes actinic radiation and non-actinic radiation;
filtering the light provided by the high energy density light source to remove the non-actinic radiation; and
scanning the light from the high energy density light source across the printing plate to form the printing features through a mask on the printing plate.

22. The method of claim 20, wherein filtering the light provided by the high energy density light source comprises providing at least one of a substrate that absorbs radiation having a wavelength shorter than actinic radiation and a coating that rejects radiation having a wavelength longer than actinic radiation in a light path between the high energy density light source and the printing plate.

23. The method of claim 22, wherein the substrate attenuates the radiation having a wavelength shorter than a wavelength of actinic radiation to an intensity less than one-eighth of an intensity of the actinic radiation.
